(19) United States
(12) Patent Application Publication
(10) Pub. No.: US 2025/0059049 A1
(43) Pub. Date: Feb. 20, 2025

(54) NEGATIVE ELECTRODE ACTIVE MATERIAL, METHOD OF PREPARING SAME, AND RECHARGEABLE LITHIUM BATTERY INCLUDING SAME

(71) Applicant: SAMSUNG SDI CO., LTD., Yongin-si (KR)

(72) Inventor: Chul YOUM, Yongin-si (KR)

(21) Appl. No.: 18/642,894

(22) Filed: Apr. 23, 2024

(30) Foreign Application Priority Data
Aug. 14, 2023 (KR) 10-2023-0106179

(51) Int. Cl. C01B 33/029; H01M 4/02; H01M 4/04; H01M 4/36; H01M 4/583; H01M 10/052

(52) U.S. Cl. CPC C01B 33/029; H01M 4/0428; H01M 4/366; H01M 4/583; H01M 10/052; C01P 2002/72; C01P 2004/64; C01P 2006/40; H01M 2004/027

(57) ABSTRACT

A negative electrode active material, a method of preparing the negative electrode active material, and a rechargeable lithium battery that includes the negative electrode active material, the negative active material includes amorphous nano-sized Si particles and the rechargeable lithium battery includes a negative electrode including the negative electrode active material, a positive electrode and an electrolyte.

### CROSS-REFERENCE TO RELATED APPLICATION

This application claims priority to and the benefit of Korean Patent Application No. 10-2023-0106179 filed in the Korean Intellectual Property Office on Aug. 14, 2023, the entire contents of which are incorporated herein by reference.

### BACKGROUND

### 1. Field

Embodiments relate to a negative electrode active material, a method of preparing the same, and a rechargeable lithium battery including the same.

### 2. Description of the Related Art

Recently, the rapid supplement of electronic devices, e.g., mobile phones, laptop computers, and electric vehicles using batteries has resulted in a surprising increase in demand for rechargeable batteries with relatively high capacity and lighter weight. The recent development of batteries with a high energy density has been required, and for this, high-capacity negative electrode active materials are needed.

### SUMMARY

Embodiments are directed to a negative electrode active material, including amorphous nano-sized Si particles.

Each of the Si particles may be about 1 nm to about 20 nm.

Each of the Si particles may be about 1 nm to about 10 nm.

The negative electrode active material may have a full-width at half maximum of about 10 or more at 20 of about 250 to about 30° in an X-ray diffraction analysis using a CuKα ray.

The negative electrode active material may further include a carbon layer on a surface of each of the Si particles.

A method of preparing a negative electrode active material, the method including adding a porous amorphous carbon matrix to a liquid silane compound to prepare a mixture; defoaming the mixture to prepare a defoamed product; performing a silane-coupling reaction on the defoamed product to prepare a silica-carbon composite; performing an oxidation treatment on the silica-carbon composite to remove the porous amorphous carbon matrix and to prepare a SiO₂ structure; subjecting the SiO₂ structure to a metal reduction process to prepare a Si structure; and forming a carbon layer on the Si structure.

The amorphous carbon matrix may include a hard carbon matrix or a soft carbon matrix.

The amorphous carbon matrix may include a hard carbon matrix.

The porous amorphous carbon matrix may have a porosity of about 1% to about 90%.

The silane compound may include tetraalkyl orthosilicate, tetraalkoxysilane, silicon tetrachloride, or a combination thereof.

Defoaming may be performed by a vacuum reduced pressure process at about 10⁻³ MPa to about 10⁻⁶ MPa.

The metal reduction process may include forming a second mixture by mixing the SiO₂ structure and a metal, sintering the second mixture, and washing the sintered second mixture.

The metal may include Mg.

A weight ratio of the SiO₂ structure and the metal may be about 1:10 to about 1:8.5.

The sintering may be performed at about 500° C. to about 800° C. under an argon atmosphere, a helium atmosphere, or a combination thereof.

The carbon layer may be formed by performing a chemical vapor deposition process.

The oxidation treatment may be performed at about 600° C. to about 750° C. under an air or an oxygen atmosphere.

The silane-coupling reaction may include distributing the defoamed product in a solvent.

The solvent may include water.

The embodiments may be realized by providing a rechargeable lithium battery, including a negative electrode having the negative electrode active material according to an embodiment; a positive electrode; and an electrolyte.

### BRIEF DESCRIPTION OF THE DRAWINGS

Features will become apparent to those of skill in the art by describing in detail exemplary embodiments with reference to the attached drawings in which:

FIG. 1 is a schematic diagram showing a rechargeable lithium battery according to one or more embodiments; and

FIG. 2 is a graph showing the X-ray diffraction analysis result using a CuKα ray for the negative electrode active material of Example 1 and Comparative Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “combination thereof may include a mixture, a laminate, a complex, a copolymer, an alloy, a blend, a reactant of constituents.

As used herein, the term “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

When an element is referred to as being “directly on” another element, there are no intervening elements present.

Herein, “layer” includes a shape totally formed on the entire surface or a shape partial surface, when viewed from a plane view.

Herein, “or” is not to be construed as an exclusive meaning, for example, “A or B” is construed to include A, B, A+B, and the like.

Unless otherwise defined in the specification, a particle diameter or size may be an average particle diameter. The average particle diameter indicates an average particle diameter (D50) where a cumulative volume is about 50 volume % in a particle distribution. The average particle diameter D50 may be measured by a suitable method, for example, by a particle size analyzer, or a transmission electron microscope image, or a scanning electron microscope image. In another embodiments, a dynamic light-scattering measurement device is used to perform a data analysis, and the number of particles is counted for each particle size range, and from this, the average particle diameter (D50) value may be easily obtained through a calculation, or a laser diffraction method.

A negative electrode active material according to one or more embodiments includes amorphous Si particles having a nano size, e.g., nano-sized amorphous Si particles.

In one or more embodiments, the nano-size indicates the size of an amorphous Si single particle, and the negative electrode active material according to one or more embodiments may include at least one amorphous Si particle having such a nano-size.

The amorphous Si single particle according to one or more embodiments may be presented in a variety of shapes, and thus, e.g., it may have irregular shape. Such irregular-shaped and amorphous Si single particle may have a nano-size, and thus, the structure may be not broken and maintained, even if volume expansion occurs during charge and discharge.

In an implementation, the nano-sized amorphous Si may be, e.g., about 1 nm to about 20 nm or about 1 nm to about 10 nm. If the size of the amorphous Si particles is a nano-size which is small, high-capacity may be exhibited, and a nano-size within the above range may further improve capacity.

Si particles may have amorphous structure, so even if the volume expansion of the Si particles occur during charging and discharging, the structure of the Si particles may not break, and thus, cracks may be not formed and the cycle-life may be further improved. If the Si particles have a crystalline structure, cracks may occur due to the volume expansion during charging and discharging, thereby deteriorating the cycle-life.

The amorphous structure of the Si particles indicates that a sharp peak may not appear at 2θ of about 25° to about 30° if an X-ray diffraction analysis using a CuKα ray is performed on one or more of the embodiments. In one or more embodiments, the absence of a sharp peak generally may include the appearance of a broad shoulder. The negative electrode active material according to one or more embodiments may have a full-width at half maximum (FWHM), e.g., a FWHM of a Si(111) plane of about 10 or more, or about 10 to 30 at 2θ of about 25° to about 30°, in an X-ray diffraction analysis using a CuKα ray.

In an implementation, the negative electrode active material may further include an amorphous carbon layer on a surface of the amorphous Si particles. Inclusion of the amorphous carbon coating layer may further improve the electrical conductivity of the negative electrode active material, thereby further improving the cycle-life characteristic, the fast charge characteristic, or the like.

In an implementation, the amorphous carbon layer may include, e.g., hard carbon, soft carbon, or a combination thereof. In an implementation, the amorphous carbon layer may be hard carbon.

If the negative electrode active material according to one or more embodiments further includes the amorphous carbon layer, the silicon expansion may be further effectively suppressed during charging and discharging, thereby further enhancing the cycle-life characteristic. The effects for suppressing the silicon expansion may be further sufficiently realized if the carbon layer is an amorphous carbon layer rather than a crystalline carbon layer.

In an implementation, the negative electrode active material may further include the amorphous carbon layer, based on a total weight of the negative electrode active material, and an amount of the amorphous Si particles may be, e.g., about 90 wt % to about 97 wt %, about 93 wt % to about 97 wt %, or about 95 wt % to about 97 wt %, and an amount of the amorphous carbon layer may be about 10 wt % to about 3 wt %, about 7 wt % to about 3 wt %, or about 5 wt % to about 3 wt %.

A thickness of the amorphous carbon layer may be appropriately adjusted.

### <Method of Preparing a Negative Electrode Active Material>

The negative electrode active material according to one or more embodiments may be prepared by the following procedures.

A porous amorphous carbon matrix may be added to a liquid silane compound to prepare a mixture. The porous amorphous carbon matrix may include at least one pore, and the amorphous carbon may be, e.g., hard carbon, soft carbon, or a combination thereof, and according to one or more embodiments, the amorphous carbon may be hard carbon.

The porous amorphous carbon matrix may have a porosity of, e.g., about 1% to about 90%, about 5% to about 80%, about 10% to about 64%, about 10% to about 60%, or about 10% to about 50%.

The addition may be performed by distributing the porous amorphous carbon matrix in the liquid silane compound.

A mixing ratio of the porous amorphous carbon matrix and the liquid silane compound may be appropriately adjusted depending on the porosity of the porous amorphous carbon matrix, and may be appropriately adjusted to have a sufficient amount to fill the liquid silane compound in the pores.

The silane compound may be used as a silicon source, and by using it in a liquid form, amorphous silicon particles may be placed in the pores of the porous amorphous carbon matrix in a suitable amount. If a silane compound is used in a vapor-form, the pores of the porous amorphous carbon matrix may be initially blocked in a deposition, leading to the undesirable deposition of the silane compound on a surface of the porous amorphous carbon matrix. Otherwise, if a silane compound is used in a pulverized solid-form, it may be unable to be positioned in the pores of the porous amorphous carbon matrix, and the size of the silane compound may not be controlled by the pores of the porous amorphous carbon matrix.

The silane compound may be, e.g., tetraalkyl orthosilicate, tetraalkoxysilane, silicon tetrachloride, or combinations thereof. The tetraalkyl orthosilicate may be, e.g., tetramethyl orthosilicate, tetraethyl orthosilicate, tetrapropyl orthosilicate, or combinations thereof. The tetraalkoxy silane may be, e.g., tetramethoxysilane, tetraethoxysilane, tetrabutoxysilane, or combinations thereof.

A defoaming may be performed on the mixture to prepare a defoamed product. The defoaming may be performed by a vacuum reduced pressure process. The defoaming may remove air in the pores of the matrix and may render to penetrate the liquid silane compound into the pores.

The defoaming may be performed under a vacuum condition. In an implementation, it may be performed under a vacuum or reduced pressure.

The pressure of the vacuum condition may be, e.g., about 10⁻³ MPa to about 10⁻⁶ MPa. If the vacuum condition is within this pressure range, air in the pores may be sufficiently removed, thereby substantially and sufficiently penetrating the liquid silane compound in the pores.

The defoamed product may be subjected to a silane-coupling reaction to prepare a silica-carbon composite. The silane-coupling reaction may be carried out by dispersing the defoamed product in a solvent. The solvent may be, e.g., water. If the defoamed product is dispersed in the solvent, e.g., water, the coupling reaction of the silane compound may occur, thereby rendering a conversion of the silane compound to SiOₓ. Because it is difficult for water to fully penetrate to the center of the porous amorphous carbon matrix, the center of the porous amorphous carbon may be presented as a silane compound itself. A process of filtrating and drying the obtained silica-carbon composite may be further performed.

Thereafter, the silica-carbon composite may be subjected to an oxidation-treatment to prepare a SiO₂ structure. The oxidation-treatment may be carried out, e.g., under an air or an oxygen atmosphere and, e.g., at about 600° C. to about 750° C., or about 600° C. to about 700° C. In an implementation, it may be carried out by sintering under the above atmosphere and the temperature conditions. If the oxidation-treatment is carried out under the conditions, amorphous Si particles may be prepared. If the temperature of the oxidation-treatment exceeds 700° C., it may not be suitable to prepare crystalline Si particles. If the temperature is less than 600° C., the porous amorphous carbon matrix may not be sufficiently removed.

The oxidation-treatment may remove the porous amorphous carbon matrix. This oxidation-treatment may render to obtain only the SiO₂ structure.

The resulting SiO₂ structure may undergo a metal reduction, thereby preparing a Si structure. The metal reduction may be performed by mixing SiO₂ and a metal powder, sintering, and washing. A mixing ratio of the SiO₂ structure and the metal may be, e.g., a weight ratio of about 1:10 to about 1:7, or a weight ratio of about 1:10 to about 1:8.5. The metal may be, e.g., Mg. The sintering may be performed under, e.g., an argon atmosphere, a helium atmosphere, or a combination thereof and at, e.g., about 500° C. to about 800° C., or about 550° C. to about 750° C. The reduction may render to reduce the SiO₂ structure to Si.

The washing process may be performed by using, e.g., HCl as a solvent. In an implementation, any solvent that may remove metal oxide, e.g., MgO, which may be generated during the reduction, may be used.

A carbon layer may be formed on the Si structure. The carbon layer forming may be performed, e.g., through a chemical vapor deposition.

The chemical vapor deposition may be performed by using a carbon source, and the carbon source may be, e.g., acetylene, coal pitch, petroleum pitch, mesophase pitch, meso carbon pitch, coal-based oil, petroleum-based heavy oil, tar, coal-based cokes, petroleum-based cokes, green cokes, low molecular weight heavy oil, or a polymer resin such as a phenol resin, a furan resin, a polyimide resin, or the like. In an implementation, the carbon source may be, e.g., acetylene, coal pitch, petroleum pitch, mesophase pitch, tar, coal-based cokes, petroleum-based cokes, green cokes, low molecular weight heavy oil, or a combination thereof, which may prepare soft carbon.

### <Rechargeable Lithium Battery>

Another embodiment provides a rechargeable lithium battery including a negative electrode, a positive electrode, and an electrolyte.

### Negative Electrode

The negative electrode may include a current collector and a negative electrode active material layer formed on the current collector and may include the negative electrode active material according to one or more embodiments.

The negative electrode active material according to some embodiments may be included as a first negative electrode active material and the negative electrode may include crystalline carbon, as a second negative electrode active material. A mixing ratio of the first negative electrode active material and the second negative electrode active material may be, e.g., a weight ratio of about 1:99 to about 50:50. In an implementation, the negative electrode active material may include the first negative electrode active material and the second negative electrode active material at a weight ratio of about 5:95 to about 20:80.

In the negative electrode active material layer, an amount of the negative electrode active material may be, e.g., about 95 wt % to about 98 wt %, based on the total weight of the negative electrode active material layer.

The negative electrode active material layer may include a binder, and may further include a conductive material. The amount of the binder may be, e.g., about 1 wt % to about 5 wt %, based on the total weight of the negative electrode active material layer. The amount of the conductive material may be, e.g., about 1 wt % to about 5 wt %, based on the total weight of the negative electrode active material layer.

The binder may improve binding properties of negative electrode active material particles with one another and with a current collector. The binder may be, e.g., a non-aqueous binder, an aqueous binder, or a combination thereof.

The non-aqueous binder may be, e.g., an ethylene propylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamide imide, polyimide, or a combination thereof.

The aqueous binder may be, e.g., a styrene-butadiene rubber (SBR), an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polypropylene, polyepichlorohydrin, polyphosphazene, an ethylene propylene diene copolymer, polyvinyl pyridine, chlorosulfonated polyethylene, latex, polyester resin, an acrylic resin, a phenolic resin, an epoxy resin, polyvinyl alcohol, or a combination thereof.

The binder may use a cellulose-based compound, or may use the cellulose-based compound together with the aqueous binder. In an implementation, the cellulose-based compound may include, e.g., carboxymethyl cellulose, hydroxypropyl methylcellulose, methyl cellulose, or alkali metal salts thereof. The alkali metal may be, e.g., Na, K, or Li. The cellulose-based compound may serve as a binder or as a thickener that may impart viscosity, and the cellulose-based compound may be used in an appropriate amount within the amount of the binder. In an implementation, it may be, e.g., about 0.1 parts by weight to about 3 parts by weight based on 100 parts by weight of the negative electrode active material.

The conductive material may be used to impart conductivity to the electrode, and any material that does not cause chemical change and conducts electrons may be used in the battery. Examples thereof may include a carbon-based material such as natural graphite, artificial graphite, carbon black, acetylene black, ketjen black, a carbon fiber; a metal-based material including copper, nickel, aluminum, silver, etc. in a form of a metal powder or a metal fiber; a conductive polymer such as a polyphenylene derivative; or a mixture thereof.

The current collector may include, e.g., a copper foil, a nickel foil, a stainless steel foil, a titanium foil, a nickel foam, a copper foam, a polymer substrate coated with a conductive metal, or a combination thereof.

### Positive Electrode

The positive electrode may include a current collector and a positive electrode active material layer on the current collector.

The positive electrode active material may include lithiated intercalation compounds that reversibly intercalate and deintercalate lithium ions. In an implementation, at least one of a composite oxide of lithium and a metal, e.g., cobalt, manganese, nickel, and combinations thereof may be used. In an implementation, the compounds represented by one of the following chemical formulae may be used. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c} Co_{b}X_{c}D¹_{α} (0.90≤a≤1.8, 0≤b≤0.5, 0≤c≤0.5, 0≤α≤2); LiₐNi_{1-b-c} Co_{b}X_{c}O_{2-α}T_{α} (0.90≤a≤1.8, 0≤b≤0.5, 0≤c≤0.5, 0<α<2); LiₐNi_{1-b-c} Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D¹_{α} (0.90≤a≤1.8, 0≤b≤0.5, 0≤c≤0.5, 0≤α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c} Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b} Co_{c}L^{l}_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) Liₐ CoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃(0≤f≤2); Li_{(3-f)}Fe₂(PO₄)₃(0≤f≤2); LiₐFePO₄ (0.90≤a≤1.8)

In the above chemical formulas, A may be, e.g., Ni, Co, Mn, or combinations thereof, X may be, e.g., Al, Ni, Co, Mn, Cr, Fe, Mg, Sr, V, a rare earth element, and combinations thereof, D¹ may be, e.g., O, F, S, P, or combinations thereof, E may be, e.g., Co, Mn, or combinations thereof, T may be, e.g., F, S, P, or combinations thereof, G may be, e.g., Al, Cr, Mn, Fe, Mg, La, Ce, Sr, V, or combinations thereof, Q may be, e.g., Ti, Mo, Mn, or combinations thereof, Z may be, e.g., Cr, V, Fe, Sc, Y, or combinations thereof, J may be, e.g., V, Cr, Mn, Co, Ni, Cu, or combinations thereof, L¹ may be, e.g., Mn, Al, or combinations thereof.

The compounds may have a coating layer on the surface, or may be mixed with another compound having a coating layer. The coating layer may include at least one coating element, e.g., an oxide of a coating element, a hydroxide of a coating element, an oxyhydroxide of a coating element, an oxycarbonate of a coating element, and a hydroxyl carbonate of a coating element. The compound for the coating layer may be, e.g., amorphous or crystalline. The coating element included in the coating layer may include, e.g., Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and, e.g., the method may include any coating method such as spray coating, dipping, and the like.

In the positive electrode, an amount of the positive electrode active material may be, e.g., about 90 wt % to about 98 wt %, based on the total weight of the positive electrode active material layer.

In an implementation, the positive electrode active material layer may further include a binder and a conductive material. The binder and the conductive material may be included in an amount of, e.g., about 1 wt % to about 5 wt %, respectively based on the total amount of the positive electrode active material layer.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, an acrylated styrene butadiene rubber, an epoxy resin, nylon, or the like.

The conductive material may be included to provide electrode conductivity, and any electrically conductive material may be used as a conductive material unless it causes a chemical change. Examples of the conductive material may include a carbon-based material such as natural graphite, artificial graphite, carbon black, acetylene black, ketjen black, a carbon fiber or the like; a metal-based material of a metal powder or a metal fiber including copper, nickel, aluminum, silver, or the like; a conductive polymer such as a polyphenylene derivative; or a mixture thereof.

The current collector may include, e.g., Al.

### Preparation of Negative Electrode and Positive Electrode

The negative electrode and the positive electrode may be prepared by mixing an active material, a conductive material, and a binder in a solvent to prepare an active material composition and coating the composition on a current collector. The solvent may be, e.g., N-methyl pyrrolidone, or the like. If the aqueous binder is used in the negative electrode, water may be used a solvent for preparing a negative electrode active material composition.

### Electrolyte

The electrolyte may include a non-aqueous organic solvent and a lithium salt.

The non-aqueous organic solvent may serve as a medium for transmitting ions taking part in the electrochemical reaction of a battery.

The non-aqueous organic solvent may include, e.g., a carbonate-based, ester-based, ether-based, ketone-based, alcohol-based, or aprotic solvent.

The carbonate-based solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester-based solvent may include methyl acetate, ethyl acetate, n-propyl acetate, dibutyl acetate, methyl propionate, ethyl propionate, decanolide, mevalonolactone, caprolactone, or the like. The ether-based solvent may include dibutyl ether, tetraglyme, diglyme, dimethoxyethane, 2-methyltetrahydrofuran, tetrahydrofuran, or the like. The ketone-based solvent may include, e.g., cyclohexanone, or the like. The alcohol-based solvent may include, e.g., ethanol, isopropyl alcohol, or the like and the aprotic solvent may include, e.g., nitriles such as R-CN (wherein R may be a C2 to C20 linear, branched, or cyclic hydrocarbon group, and may include a double bond, an aromatic ring, or an ether bond, and the like); amides such as dimethylformamide; dioxolanes such as 1,3-dioxolane, or the like; sulfolanes, or the like.

The organic solvent may be used alone or in a mixture. If the organic solvent is used in a mixture, the mixture ratio may be controlled in accordance with a desirable battery performance.

The carbonate-based solvent may suitably include a mixture of a cyclic carbonate and a linear carbonate. The cyclic carbonate and linear carbonate may be mixed together in a volume ratio, e.g., of about 1:1 to about 1:9. If the mixture is used as an electrolyte, it may have enhanced performance.

In an implementation, the organic solvent may further include an aromatic hydrocarbon-based solvent as well as the carbonate-based solvent. The carbonate-based solvent and aromatic hydrocarbon-based solvent may be mixed together in a volume ratio, e.g., of about 1:1 to about 30:1.

The aromatic hydrocarbon-based organic solvent may be, e.g., an aromatic hydrocarbon-based compound represented by Chemical Formula 1.

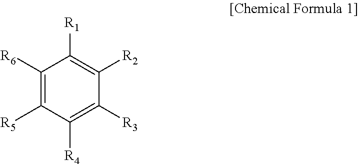

(In Chemical Formula 1, R₁ to R₆ may be the same or different and may be, e.g., hydrogen, a halogen, a C1 to C10 alkyl group, a haloalkyl group, or a combination thereof.)

Examples of the aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include, e.g., vinylethyl carbonate, vinylene carbonate, or an ethylene carbonate-based compound represented by Chemical Formula 2, as an additive for improving cycle life.

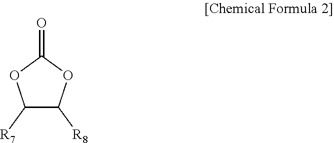

(In Chemical Formula 2, R₇ and R₈ may be the same or different and may each independently be, e.g., hydrogen, a halogen, a cyano group (CN), a nitro group (NO₂), or a C1 to C5 fluoroalkyl group, provided that at least one of R₇ and R₈ is, e.g., a halogen, a cyano group (CN), a nitro group (NO₂), or a C1 to C5 fluoroalkyl group, and R₇ and R₈ are not simultaneously hydrogen.)

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, or the like. In case of further using the additive for improving cycle life, an amount of the additive may be suitably controlled within an appropriate range.

The lithium salt dissolved in an organic solvent may supply a battery with lithium ions, basically operates the rechargeable lithium battery, and may improve transportation of the lithium ions between positive and negative electrodes. Examples of the lithium salt may include, e.g., LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide:LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), where x and y are each a natural number, e.g., an integer of about 1 to about 20, lithium difluoro(bisoxalato)phosphate), LiCl, LiI, LiB(C₂O₄)₂(lithium bis(oxalato) borate:LiBOB) or lithium difluoro(oxalato)borate, (LiDFOB). A concentration of the lithium salt may range, e.g., from about 0.1 M to about 2.0 M. If the lithium salt is included at the above concentration range, an electrolyte may have excellent performance and lithium ion mobility owing to optimal electrolyte conductivity and viscosity.

### Separator

A separator may be disposed between the positive electrode and the negative electrode depending on a type of a rechargeable lithium battery. The separator may use, e.g., polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and the like.

The separator may include, e.g., a porous substrate and a coating layer including an organic material, an inorganic material, or a combination thereof on one or both surfaces of the porous substrate.

The porous substrate may be a polymer film formed of, e.g., a polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness of, e.g., about 1 μm to about 40 μm, e.g., about 1 μm to about 30 μm, about 1 μm to about 20 μm, about 5 μm to about 15 μm, or about 10 μm to about 15 μm.

The organic material may include, e.g., a (meth)acryl-based copolymer including a first structure unit derived from (meth)acrylamide, and a second structure unit including at least one a structure unit derived from (meth)acrylic acid or a structure derived from (meth)acrylate, and (meth)acrylamido sulfonate, or a salt thereof.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof. The inorganic particle may have an average particle diameter D₅₀ of, e.g., about 1 nm to about 2000 nm, for about 100 nm to about 1000 nm, or about 100 nm to about 700 nm.

The organic material and the inorganic material may exist mixed together in one coating layer, or may exist in a stacked form of a coating layer including an organic material and a coating layer including an inorganic material.

The coating layers may have respectively, a thickness of, e.g., about 0.5 μm to about 20 μm, e.g., may have a thickness of about 1 μm to about 10 μm, or about 1 μm to about 5 μm.

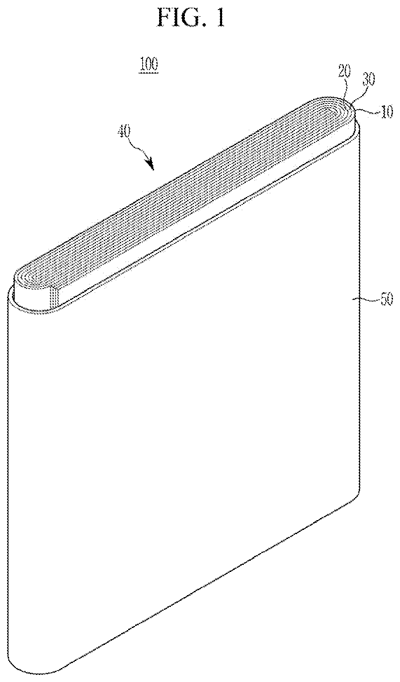

FIG. 1 is a schematic diagram showing a rechargeable lithium battery according to one or more embodiments. The rechargeable lithium battery according to an embodiment is illustrated as a prismatic battery but may include variously-shaped batteries such as a cylindrical battery, a pouch battery, and the like.

Referring to FIG. 1, a rechargeable lithium battery 100 according to an embodiment may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20 and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

A porous hard carbon matrix (porosity: 10%) was added to liquid tetraethyl orthosilicate (TEOS) to prepare a mixture. A mixing ratio of the porous hard carbon matrix and the liquid tetraethyl orthosilicate was a weight ratio of 1:10.

The mixture was defoamed by vacuum reduced pressure of 10⁻⁶ MPa pressure.

The defoamed product was distributed in water and subjected to a silane-coupling reaction. According to this procedure, a SiO₂-carbon composite was prepared.

The prepared SiO₂-carbon composite was subjected to an oxidation treatment under an oxygen atmosphere at 600° C. to remove the porous hard carbon matrix, and then to prepare a SiO₂ structure.

The SiO₂ was subjected to a Mg reduction treatment, thereby preparing a Si structure. The Mg reduction treatment was carried out by mixing the SiO₂ structure with Mg powder, sintered at 650° C. under an argon atmosphere, and washed with HCl.

Thereafter, a chemical vapor deposition using acetylene was performed on the Si structure, thereby preparing a negative electrode active material including amorphous Si particles with an average particle diameter (D50) of 5 nm and a soft carbon coating layer on the surface of the Si particles.

Based on the total weight of the negative electrode active material, an amount of the Si particles was 95 wt % and an amount of the soft carbon coating layer was 5 wt %.

97.5 wt % of the prepared negative electrode active material, 1 wt % of carboxymethyl cellulose, and 1.5 wt % of a styrene butadiene rubber were mixed in a water solvent to prepare a negative electrode active material layer slurry.

The negative electrode active material slurry was coated on a Cu foil current collector, dried, and pressurized to prepare a negative electrode active material layer, thereby obtaining a negative electrode.

Using the negative electrode, a counter electrode, and an electrolyte, a rechargeable lithium cell was fabricated. As the electrolyte, a 1 M LiPF₆ solution in a mixed solvent of ethylene carbonate and dimethyl carbonate (3:7 volume ratio) was used.

### Example 2

A negative electrode active material including amorphous Si particles with an average particle diameter (D50) of 5 nm and a soft carbon coating layer on the surface of the Si particles, was prepared by the same procedure as in Example 1, except that the oxidation treatment was carried out under an oxygen atmosphere at 700° C.

The negative electrode active material was used to prepare a negative electrode and a half-cell by the same procedure as in Example 1.

### Comparative Example 1

A negative electrode active material including crystalline Si particles with an average particle diameter (D50) of 5 nm and a soft carbon coating layer on the surface of the Si particles, was prepared by the same procedure as in Example 1, except that the oxidation treatment was carried out under an oxygen atmosphere at 800° C.

The negative electrode active material was used to prepare a negative electrode and a half-cell by the same procedure as in Example 1.

### Comparative Example 2

A negative electrode active material including amorphous Si nanowire with an average particle diameter (D50) of 5 nm and a soft carbon coating layer on the surface of the Si nanowire, was prepared by the same procedure as in Example 1, except that the Mg reduction was not performed.

The negative electrode active material was used to prepare a negative electrode and a half-cell by the same procedure as in Example 1.

### Experimental Example 1) Evaluation of X-Ray Diffraction

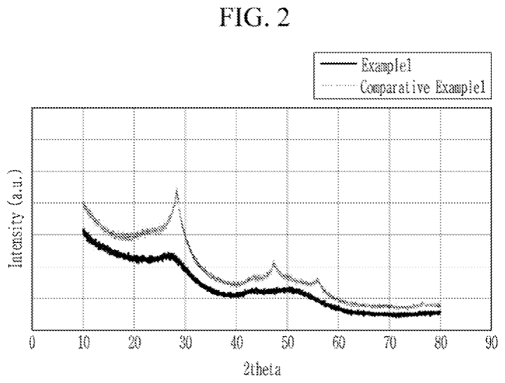

An X-ray diffraction analysis using a CuKα ray was performed on the negative electrode active materials according to Examples 1 and 2, and Comparative Examples 1 and 2, were performed. Among these results, the results of Example 1 and Comparative Example 1 are shown in FIG. 2. As shown in FIG. 2, the negative electrode active material of Example 1 showed a broad shoulder (FWHM=12) at 2θ of 25° to 30° and did not show a sharp peak. It may be seen from these results that the negative electrode active material according to Example 1 is amorphous. Comparative Example 1 showed a sharp peak (FWHM=4), indicating crystalline.

The crystallinity of the negative electrode active material according to the X-ray diffraction analysis is shown in Table 1.

### Experimental Example 2) Evaluation of Charge and Discharge Capacity

The half-cells according to Examples 1 and 2, and Comparative Examples 1 and 2 were once charged and discharged at 0.1 C to measure charge and discharge capacities. The measured discharge capacity is shown in Table 1.

### Experimental Example 3) Evaluation of Efficiency

The half-cells according to Examples 1 and 2, and Comparative Examples 1 and 2 were once charged and discharged at 0.1 C. A ratio of discharge capacity relative to charge capacity was calculated. The results are shown in Table 1.

### Experimental Example 4) Evaluation of Cycle-Life Characteristic

The half-cells according to Examples 1 and 2, and Comparative Examples 1 and 2 were charged and discharged at 1 C for 500 cycles. A ratio of discharge capacity at 500^{th} cycle relative to discharge capacity at 1^{st} cycle was calculated. The results are shown in Table 1.

TABLE 1

| | | | Si average particle | | | | Cycle-life |
|---|---|---|---|---|---|---|---|
| | Crystallinity | | diameter | Si(111) | Capacity | Efficiency | retention |
| | of Si | Type of Si | (D50, nm) | FWHM | (mAh/g) | (%) | (%) |
| Example 1 | Amorphous | Particle | 5 | 12 | 2250 | 92 | 95 |
| | | (irregular | | | | | |
| | | shape) | | | | | |
| Example 2 | Amorphous | Particle | 5 | 10 | 2230 | 93 | 94 |
| | | (irregular | | | | | |
| | | shape) | | | | | |
| Comparative | Crystalline | Particle | 5 | 4 | 2235 | 93 | 41 |
| Example 1 | | (irregular | | | | | |
| | | shape) | | | | | |
| Comparative | Amorphous | nanowire | 5 (average | 12 | 1755 | 72 | 63 |
| Example 2 | | | diameter) | | | | |

As shown in Table 1, Examples 1 and 2 including amorphous Si having a nano size exhibited excellent capacity, efficiency, and cycle-life retention. Whereas, Comparative Example 1 including crystalline Si particles exhibited good capacity and efficiency, but abruptly deteriorated cycle-life retention. Comparative Example 2 including amorphous Si, but with a nanowire type, exhibited deteriorated capacity, efficiency and cycle-life retention.

By way of summation and review, there have been attempts to use a Si-based negative electrode active material as the high-capacity negative electrode active material. One or more embodiments of the instant disclosure provides a negative electrode active material exhibiting excellent cycle-life characteristic. Another embodiment provides a method of preparing the negative electrode active material. Still another embodiment provides a rechargeable lithium battery including the negative electrode active material.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material, comprising amorphous nano-sized Si particles.

2. The negative electrode active material as claimed in claim 1, wherein each of the Si particles is about 1 nm to about 20 nm.

3. The negative electrode active material as claimed in claim 1, wherein each of the Si particles is about 1 nm to about 10 nm.

4. The negative electrode active material as claimed in claim 1, wherein the negative electrode active material has a full-width at half maximum of about 10 or more at 2θ of about 250 to about 300 in an X-ray diffraction analysis using a CuKα ray.

5. The negative electrode active material as claimed in claim 1, wherein the negative electrode active material further comprises a carbon layer on a surface of each of the Si particles.

6. A method of preparing a negative electrode active material, the method comprising:
adding a porous amorphous carbon matrix to a liquid silane compound to prepare a mixture;
defoaming the mixture to prepare a defoamed product;
performing a silane-coupling reaction on the defoamed product to prepare a silica-carbon composite;
performing an oxidation treatment on the silica-carbon composite to remove the porous amorphous carbon matrix and to prepare a SiO₂ structure;
subjecting the SiO₂ structure to a metal reduction process to prepare a Si structure; and
forming a carbon layer on the Si structure.

7. The method of preparing a negative electrode active material as claimed in claim 6, wherein the amorphous carbon matrix comprises a hard carbon matrix or a soft carbon matrix.

8. The method of preparing a negative electrode active material as claimed in claim 6, wherein the amorphous carbon matrix comprises a hard carbon matrix.

9. The method of preparing a negative electrode active material as claimed in claim 6, wherein the porous amorphous carbon matrix has a porosity of about 1% to about 90%.

10. The method of preparing a negative electrode active material as claimed in claim 6, wherein the silane compound comprises tetraalkyl orthosilicate, tetraalkoxysilane, silicon tetrachloride, or a combination thereof.

11. The method of preparing a negative electrode active material as claimed in claim 6, wherein defoaming is performed by a vacuum reduced pressure process at about 10⁻³ MPa to about 10⁻⁶ MPa.

12. The method of preparing a negative electrode active material as claimed in claim 6, wherein the metal reduction process comprises:
forming a second mixture by mixing the SiO₂ structure and a metal,
sintering the second mixture, and
washing the sintered second mixture.

13. The method of preparing a negative electrode active material as claimed in claim 12, wherein the metal comprises Mg.

14. The method of preparing a negative electrode active material as claimed in claim 12, wherein a weight ratio of the SiO₂ structure and the metal is about 1:10 to about 1:8.5.

15. The method of preparing a negative electrode active material as claimed in claim 12, wherein the sintering is performed at about 500° C. to about 800° C. under an argon atmosphere, a helium atmosphere, or a combination thereof.

16. The method of preparing a negative electrode active material as claimed in claim 6, wherein the carbon layer is formed by performing a chemical vapor deposition process.

17. The method of preparing a negative electrode active material as claimed in claim 6, wherein the oxidation treatment is performed at about 600° C. to about 750° C. under an air or an oxygen atmosphere.

18. The method of preparing a negative electrode active material as claimed in claim 6, wherein the silane-coupling reaction comprises distributing the defoamed product in a solvent.

19. The method of preparing a negative electrode active material as claimed in claim 18, wherein the solvent comprises water.

20. A rechargeable lithium battery, comprising:
a negative electrode comprising a negative electrode active material of claim 1;
a positive electrode; and
an electrolyte.
